(19) United States
(12) Patent Application Publication
(10) Pub. No.: US 2026/0273724 A1
(43) Pub. Date: Sep. 17, 2026

(54) MODULAR SOFT ROBOTIC SYSTEM

(71) Applicant: The Regents of the University of Michigan, Ann Arbor, MI (US)

(72) Inventors: Xiaonan Huang, Ann Arbor, MI (US); Jiaqi Wang, Ann Arbor, MI (US); Jiyang Wang, Ann Arbor, MI (US); Xinqi Zhang, Ann Arbor, MI (US)

(21) Appl. No.: 19/566,948

(22) Filed: Mar. 13, 2026

Related U.S. Application Data
(60) Provisional application No. 63/772,113, filed on Mar. 14, 2025.

(51) Int. Cl. B25J 9/00; B25J 9/08; B25J 9/14; B25J 9/16

(52) U.S. Cl. CPC B25J 9/0015; B25J 9/08; B25J 9/142; B25J 9/1697

(57) ABSTRACT

A modular soft robotic system includes multi-tube actuator modules that can be operably connected end-to-end to form a modular soft robotic assembly, such as a soft robotic arm or a soft robot able to travel along horizontal or vertical surfaces. The soft robotic assembly includes a base module and, optionally, one or more extension modules. Each module includes a plurality of flexible tube actuators extending between first and second rigid end portions. The actuators are capable of linear expansion via changes of internal fluid pressure and can be arranged to additionally enable bending motions of each module. When configured as a traveling soft robot, each module includes feet at its opposite ends that temporarily anchor one end of the module to a surface while the other end moves over the surface.

### TECHNICAL FIELD

This disclosure is related to soft robotics and, in particular, to modular soft robotics actuators having movement controlled by changes in fluid pressure.

### BACKGROUND

Soft robots holds promise for 3D terrain exploration and for use in place of rigid robot arms due to their intrinsic compliance and impact resistance and, in some cases, adaptive adhesion capabilities. Soft robots have been developed that emulate an inchworm's locomotion along to top side of horizontal surfaces. Attempts have been made to develop such robots for movement along vertical surfaces, along the bottom of horizontal surfaces, and across transitions between vertical and horizontal surfaces. While some vertical-climbing soft robots have been reported, their ability to transition to or from vertical surfaces has been limited. Additionally, vertical-climbing soft robots to date have been unable to make turns on vertical surfaces, greatly limiting their 3D-exploration utility. The use of soft robotics as robotic arms has similarly been limited by their inability to perform certain 3D movements at the effector-end of the arm.

### SUMMARY

Embodiments of a modular soft robotic system include a plurality of multi-tube actuator modules configured to be operably connected end-to-end. Each actuator module has a plurality of flexible tube actuators extending between first and second rigid end portions, and each actuator of each module has a length that is individually controllable by modulating an internal fluid pressure of the respective actuator. The first end portion of each module is configured for removable attachment to the second end portion of another of the modules to form a modular soft robotic assembly in which each module is in electrical communication with a controller and in fluidic communication with a fluid pump. The modular soft robotic system may include any one or more of these features along with any one or more of the following features in any technically feasible combination:
each actuator module includes an actuation board at one of the end portions and a sensing board at one of the end portions, the actuation board having a plurality of valves, and the sensing board having a plurality of angle sensors;
the internal pressure of each actuator is modulated by controlling a corresponding one of the plurality of valves, and a change in the length of each actuator is monitored via a corresponding one of the plurality of angle sensors;
each actuator module includes a control board that includes the actuation board and the sensing board at the same end portion of the module, the control board having a controller configured to change the length of each actuator by modulating the internal fluid pressure of the respective actuator using the valves and monitoring the change in the length of each actuator using the angle sensors;
the actuation board is at one of the end portions and the sensing board is at the other of the end portions, one of the actuation or sensing boards having a controller configured to change the length of each actuator by modulating the internal fluid pressure of the respective actuator using the valves and monitoring the change in the length of each actuator using the angle sensors;
the actuation board of one module is operably connected with the sensing board of another module when two of the modules are removably attached to each other.

Embodiments of a modular soft robotic assembly may be formed from the modular soft robotic system having any technically feasible combination of the previously listed features. The modular soft robotic assembly may include any technically feasible combination of the following features:
at least two multi-tube actuator modules operably connected end-to-end, one of the at least two actuator modules being a base module and each of the other of the at least two actuator modules being an extension module;
the base module includes a main control board, and each extension module includes a microcontroller;
each microcontroller controls the length of each of the respective actuators by modulating the internal fluid pressure of each actuator based on commands from the main control board;
a sensing system board removably attached to one of the extension modules, the sensing system board being configured for operable connection with a camera at a distal end of the assembly;
the base module has a greater number of actuators than each extension module;
the actuators of the base module have a greater wall thickness than the actuators of each extension module;
the fluid pump is in fluidic communication with valves of each actuator module, and the assembly additionally includes an untethered power source and feet at each end portion, the power source powering the fluid pump and actuator module, and the feet being configured to controllably attach and detach the respective end portion to a surface supporting the robotic assembly, whereby the robotic assembly is an untethered soft robot;
a sensor configured to detect objects, the main control board being configured to receive information about detected objects and control extension and retraction of each actuator of each actuator module based on the received information.

Embodiments of an untethered soft robot include a plurality of flexible tube actuators and feet at opposite ends of the actuators. The flexible tube actuators are configured to extend and retract via changes in internal fluid pressure, and each foot is configured to temporarily and controllably fix the position of a respective portion of the robot with respect to a surface supporting the robot. The untethered soft robot may include any technically feasible combination of the previously listed system or assembly features along with any technically feasible combination of the following features:
each actuator retracts by folding along fold lines defined along a wall of the actuator, and each actuator extends by unfolding along the fold lines;
first and second rigid end portions at opposite ends of the actuators, one end of each actuator being rigidly attached to one of the rigid end portions and the other end of each actuator being attached to the other of the rigid end portions with a rotational degree of freedom;
the plurality of actuators includes three actuators with central axes of the actuators arranged in a triangular pattern at each of the first and second rigid end portions;
a sensor configured to detect objects and a controller configured to receive information about detected objects and control extension and retraction of each actuator based on the received information;
an untethered power source, a pump powered by the power source, and a plurality of separately controllable valves, each valve selectively interconnecting the pump with an internal volume of one of the actuators or with one of the feet;
a controller configured to open and close each valve to independently control extension and retraction of each actuator and attachment and detachment of each of the feet from the surface supporting the robot;
a first module that includes the plurality of actuators and the feet, the actuators extending between first and second rigid end portions, the feet being attached to each end portion, and the robot further comprising a second module that includes: a plurality of additional and identical actuators extending between one of the rigid end portions and an additional rigid end portion, additional and identical feet attached to the additional end portion, and a controller mounted to one of the end portions and configured to extend and retract each actuator of each module and activate and deactivate each foot of each module.

### BRIEF DESCRIPTION OF THE DRAWINGS

FIG. 1 is a perspective side view of an embodiment of a soft robot.

FIG. 2 is perspective side view of an axially repeating unit of the actuators of the robot of FIG. 1.

FIG. 3 is a reverse-angle and partially exploded perspective view of the rear end of the robot of FIG. 1 the rear housing omitted.

FIG. 4 is a plan view of the rear-facing side of the control board of FIG. 3.

FIG. 5 is a plan view of the front-facing side of the control board of FIGS. 3 and 4

FIG. 6A schematically illustrates a relationship between the amount of rotation of an end of an actuator and its change in length, and FIG. 6B graphically illustrates that relationship.

FIG. 7 schematically illustrates linear movement of the robot along an upwardly facing horizontal surface.

FIGS. 8A-8D are overhead photographic images illustrating multiple bending movements of a prototype soft robot as in FIG. 1.

FIGS. 9A and 9B are photographic images of the prototype robot of FIGS. 8A-8D ambulating along a path through several differently shaped and differently colored objects along the ground.

FIGS. 10A-10D are photographic images of a floor-to-wall transition being performed by the prototype robot of FIGS. 8A-9B.

FIG. 11 illustrates an embodiment of a soft robot including two actuator modules.

FIG. 12 is a perspective view of an embodiment of a modular soft robotic assembly including a base actuator module and extension modules.

FIG. 13 is partially exploded view of the soft robotic assembly of FIG. 12.

FIG. 14 is a perspective view of one side of a control board of the base module of FIGS. 12 and 13.

FIG. 15 is a perspective view of the opposite side of the control board of FIG. 14.

FIG. 16 is a perspective view of one side of the control boards of the extension modules of FIGS. 12 and 13.

FIG. 17 is a perspective view of the opposite side of the control board of FIG. 16.

FIG. 18 schematically illustrates closed-loop control of actuator length using multi-valve control.

FIG. 19 is a perspective view of another example of actuator modules that can be configured as base modules or extension modules to form a soft robotic assembly.

FIG. 20 is an enlarged view of the interface between the modules of FIG. 19.

FIG. 21 is a plan view of the valve side of the actuation board at one end portion of each module of FIG. 19.

FIG. 22 is a plan view of the sensor side of the sensing board at the other end portion of each module of FIG. 19.

FIG. 23 is a plan view of the opposite side of the sensing board of FIG. 22.

FIG. 24 is a plan view of the valve side of a control board for use at an end portion of one of the modules of FIG. 19 to form a base module.

FIG. 25 is a plan view of the opposite side of the control board of FIG. 24.

FIG. 26 is a plan view of a camera side of a sensor system board for use with one of the modules of FIG. 19.

FIG. 27 is a plan view of the opposite side of the sensor system board of FIG. 26.

FIGS. 28A-28C are photographic images of a working prototype of a modular robotic arm sequentially showing step of attaching an extension module to a base module.

### DESCRIPTION OF EMBODIMENTS

Described below are soft robotics based on flexible tube actuators that extend and retract via changes in internal fluid pressure. Certain geometric arrangements of such actuators combined with independent control of the fluid pressure in each actuator results in a robot exhibiting omnidirectional movement of one end with respect to another end of the robot.

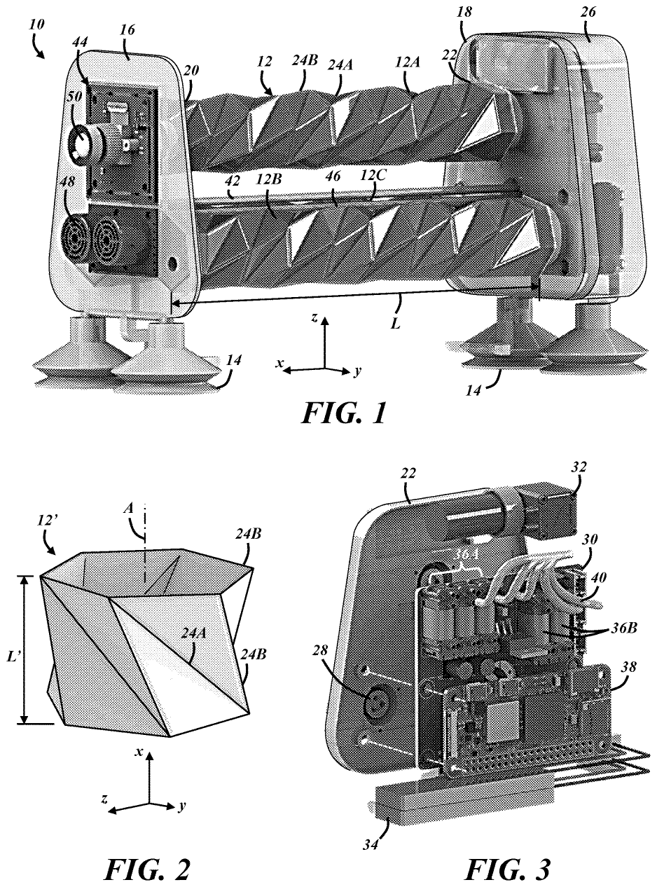

FIG. 1 is a perspective side view of a soft robot 10. As used herein, a robot is a machine that exhibits computer-controlled movement emulating movement of a living creature or part of a living creatures (e.g., a robotic arm). A soft robot 10 is characterized by compliant materials rather than the rigid links of conventional robots and have physically flexible and elastic bodies. The illustrated robot 10 includes a plurality of flexible tube actuators 12 and feet 14 located at opposite ends of the actuators on rigid portions 16, 18 between which the actuators extend. Each actuator 12 is configured to extend and retract—i.e., change length L—via changes in internal fluid pressure, and each foot 14 is configured to controllably attach and detach a respective portion of the robot 10 to a surface supporting the robot. In this case, the feet 14 are suction cups that attach to and detach from the underlying surface via respective fluid pressure reductions and increases between the concave side of the cup and the surface. The feet 14 can be any components configured to temporarily and controllably fix the position of a portion of the robot 10 to the surface supporting (e.g., magnetic, shape-memory materials, friction, etc.). In operation, the illustrated robot 10 exhibits caterpillar-like movement and may be referred to as a crawler. In another embodiment, the robot 10 includes feet 14 that controllably apply outward forces (in the y-z plane of FIG. 1) to opposing walls of a structure (e.g., the inside of a pipe) and rely on friction to temporarily fix the position of one rigid portion 16, 18 while the other rigid portion changes position along the structure to attain the crawling motion.

The illustrated robot 10 includes three flexible tube actuators 12, including a first (or upper) actuator 12A, and second and third (or lower) transversely spaced actuators 12B, 12C (behind 12B in FIG. 1). A first end 20 of each actuator 12 is coupled with a first or front rigid portion 18 of the robot 10, and a second end 22 of each actuator is coupled with a second or rear rigid portion 18 of the robot. The rigid portions 16, 18 may be in the form of plates, as shown, and may be referred to as end portions, indicating their position at the ends 20, 22 of the actuators 12. The rigid portions 16, 18 are rigid relative to the actuators 12 and may be fabricated from a non-elastomeric plastic (e.g., PLA) or other suitably rigid material that does not deform during extension and retraction of the actuators. In this particular example, the first ends 20 are rigidly attached to the first end portion 16, and the second ends 22 are rotatably coupled with the second end portion 18 such that the second ends 22 have a rotational degree of freedom about a central axis A (FIG. 2) of the respective actuator 12. This is because the particular mode of extension and retraction of the illustrated actuators 12 results in the ends 20, 22 of each actuator rotating with respect to each other about the central axis. The second end 22 of each actuator 12 may for example be closed-off by an end wall that has a post or shaft extending into a bearing installed in the second end portion 18. In other examples, both ends 20, 22 of each actuator 12 may be rigidly attached to the respective end portions 16, 18.

The actuators 12 are in their fully extended condition in FIG. 1, which is their free or relaxed condition in this example, such that all of the actuators are the same length L. The arbitrary cartesian coordinate system in FIG. 1 is that of the robot 10, with the central axes of the free-state actuators 12 extending in a longitudinal (x) direction and perpendicular with a plane extending in the transverse (y) and vertical (z) directions. In this state, the central axis of each actuator 12 is straight and parallel with the axes of the other actuators. When the robot 10 exhibits bending along its length, the central axes are curvilinear. The couplings of the actuators 12 with the end portions 16, 18 are arranged in a triangular pattern, with the central axes of the actuators intersecting the end portions at apexes of an equilateral triangle.

Each actuator 12 is made from a flexible and elastic material such as a soft plastic or elastomer (e.g., TPE) and has an internal volume delimited by an inner surface of the tube between its opposite ends 20, 22. Each actuator 12 extends at a relatively high internal fluid pressure (e.g., atmospheric pressure) and retracts at a relatively low internal fluid pressure (e.g., below atmospheric pressure). The working fluid may be a gas, such as air, or liquid. Each actuator 12 retracts (shortens) by folding along fold lines 24 defined along the wall of the tube actuator and extends (lengthens) by unfolding along the fold lines. As shown in FIG. 1, the fold lines 24 may be arranged in a pattern reminiscent of origami, with a repeating series of triangles defined by the fold lines and each triangle sharing sides and vertices with adjacent triangles. In the free state of FIG. 1, some of the fold lines 24 are defined along partial valley folds 24A, and some are defined along partial mountain folds 24B.

The fold lines 24 may be in a Kresling-like pattern, which is named for a naturally occurring pattern of fold lines along which a thin-walled cylindrical tube will buckle when subjected to sufficient axial compression and torque. Rather than circular ends, the illustrated actuators 12 have regular hexagonal ends with an axially repeating unit 12′ that is illustrated in FIG. 2. At every axial unit length L′, partial mountain folds 24B form a hexagon in a plane perpendicular to the central axis A with the hexagons at opposite ends of the repeating unit 12′ rotated about the central axis A by 15 degrees. The repeating unit 12′ is similar in shape to a hexagonal tube whose ends have been twisted relative to each other by 15 degrees with partial mountain folds 24B connecting corresponding vertices of the hexagonal ends and partial valley folds 24A at diagonals of each facet of the hexagonal tube. This is only one example of a suitable pattern of fold lines 24. The ends of the axial unit 12′ could be other regular polygons, the relative angular position of sequential polygons may vary, and the unit length L′ may vary, for example.

When a vacuum is applied to each actuator 12—i.e., when fluid is drawn out of the actuator to reduce the internal fluid pressure—the actuator retracts, or shortens. As described further below, repeated actuator 12 extensions and retractions can be combined with temporally defined activation and deactivation of the feet 14 to result in caterpillar-like crawling movement of the robot 10 along a surface. The robot is also capable of controlled 3D-bending along the length of the actuators 12, which is also described further below.

Pressure regulation within the actuators 12, along with activation and deactivation of the suction cup feet 14, is effected by a pump in fluidic communication with the internal volume of each actuator 12 and with the concave side of each suction cup 14 via a series of valves. The illustrated robot 10 is an untethered robot, meaning that the robot carries its own power source, pump, valves, and controller. The robot 10 also does not rely on external observations as part of its control feedback loop. In the example of FIG. 1, the motion control and other components are contained in a housing 26 at an end of the robot 10 on the opposite side of the second end portion 18 from the actuators 12.

FIG. 3 is a reverse-angle and partially exploded perspective view of the rear end of the robot 10 with the housing 26 removed. In this view, the opposite side of the second end portion 18 is visible, along with shafts 28 of the rotatable couplings that extend through the thickness of the plate 18. A control board 30, pump 32, and power source 34 (e.g., a battery) are mounted to the plate 18 and/or within the housing 26. Mounted on a first side of the control board 30 (visible in FIG. 3) are actuator valves 36A, suction cup valves 36B, and a controller 38. A manifold 40 fluidly connects the pump 32 with each of the valves 36. While not shown explicitly here, each actuator valve 36A is in fluidic communication with the internal volume of a respective one of the actuators 12 (e.g., via channels in the shafts 28 or plate 18), and each suction cup valve 36B is in fluidic communication with a respective pair (front or rear) of the suction cups 14. The pump 32 may be in fluidic communication with the suction cups 14 at the first end portion 16 via pressure a line 42 (FIG. 1).

Referring again to FIG. 1, the robot 10 includes a sensor system 44 configured to detect objects in the environment in front of the robot. The sensor system 44 is in communication with the controller 38 of the control board 30, which receives information from the sensor system, processes the information, and controls the actuators 12 based on the processed information—e.g., by controlling the actuator valves 36A to selectively extend or retract each individual actuator to achieve the desired movement. In this example, the sensor system 44 is in communication with the controller 38 via a communication line 46. In some embodiments, sensor communication with the controller 38 is wireless. The pressure and communication lines 42, 46 may be located beneath the top actuator 12A and centered between the lower actuators 12B, 12C as shown such that, when the actuators retract, slack in the lines 42, 46 falls between the lower actuators 12B, 12C.

The illustrated sensor system 44 includes distance sensors 48 and an optical sensor 50. The distance sensors 48 may be ultrasonic distance sensors, and the optical sensor 50 may be a camera. In other embodiments, the distance sensors 48 are radar, lidar, or other suitable distance sensors. The optical sensor 50 may be part of a vision system configured to recognize shapes, colors, and/or relative positions of objects within the sensor's field of view. A combination of imagery from the optical sensor 50 and distance information from the distance sensors 48 enables the controller 38 to navigate the robot 10 with respect to objects in its path. Other types of optical sensors 50 may be used, such as infrared sensors to optically recognize relative object temperatures. The sensor system 44 may include other types of object sensors, such as mechanical microswitches.

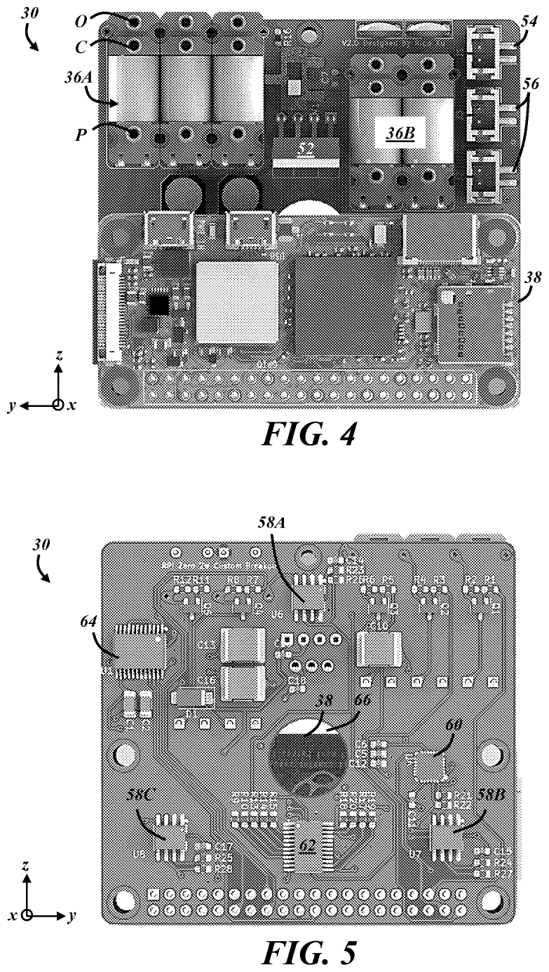

FIG. 4 is a plan view of the rear-facing side of the control board 30 of FIG. 3. The control board 30 in this case is a printed circuit board (PCB) with the actuator valves 36A and suction cup valves 36B mounted thereon and with the controller 38 mounted out-of-plane and parallel with the control board 30. The illustrated control board also includes a switching voltage regulator 52 to convert incoming power to a voltage suitable for operating the control board 30, a pump power plug 54 from which the pump 32 (FIG. 3) receives power, and power source plugs 56 by which the control board receives power from the power source 34 (FIG. 3).

The actuator valves 36A and suction cup valves 36B are identical in this example and may be solenoid valves. The illustrated valves 36A-B each have a pump port P in fluidic communication with the air pump 32, a connection port C in fluidic communication with a respective actuator 12 or suction cup 14, and an open port O that is open to atmosphere. Each valve 36 operates under the control of the controller 38 to selectively switch the pump port P between fluidic communication with the connection port C, to retract the respective actuator 12 or activate the respective suction cup 14, and fluidic communication with the open port O, to extend the respective actuator or deactivate the respective suction cup. The pump 32 may be an air pump with its air-intake side in fluidic communication with the pump ports P and its discharge side open to atmosphere. With the pump 32 operating and the valves 36 open to atmosphere via the open ports O, the actuators 12 are extended to their free state of FIG. 1 and the suction cups are deactivated (unattached to the underlying surface). A command from the controller 38 to any one of the valves 36 switches that valve to apply the vacuum generated by the pump 32 to the respective actuator 12 to retract the actuator or to the respective suction cup 14 to activate it and attach it to the underlying surface.

The controller 38 is any suitable computer-based controller including, for example, a microprocessor and memory (e.g., non-transient memory) storing executable instructions by which the microprocessor controls movement of the robot based on sensors as inputs and the valves 36 as controlled outputs. One suitable commercially available controller 38 is a Raspberry Pi Zero 2 W (Raspberry Pi, Cambridge, England).

FIG. 5 is a plan view of the front-facing side of the control board 30 of FIGS. 3 and 4—i.e. the side of the control board 30 facing the second end portion 18 of the robot 10. This side of the control board 30 includes shaft angle sensors 58, an inertial measurement unit (IMU) 60, a multiplexer 62, and a motor driver 64. There is one shaft angle sensor 58A-58C corresponding to each one of the actuators 12A-C. In this example, the shaft angle sensors 58 are integrated circuits and may be Hall effect sensors that determine shaft angle by sensing the orientation of a rotating magnetic field generated by a magnet mounted at the end of the shaft 28 of each rotational coupling of the second ends 22 of the actuators 12 to the second end portion 18. The shaft angle sensors 58 may function as encoders and the controller 38 may be configured to determine the instant amount of extension (i.e., the instant length) of the associated actuator 12 from the instant shaft angle.

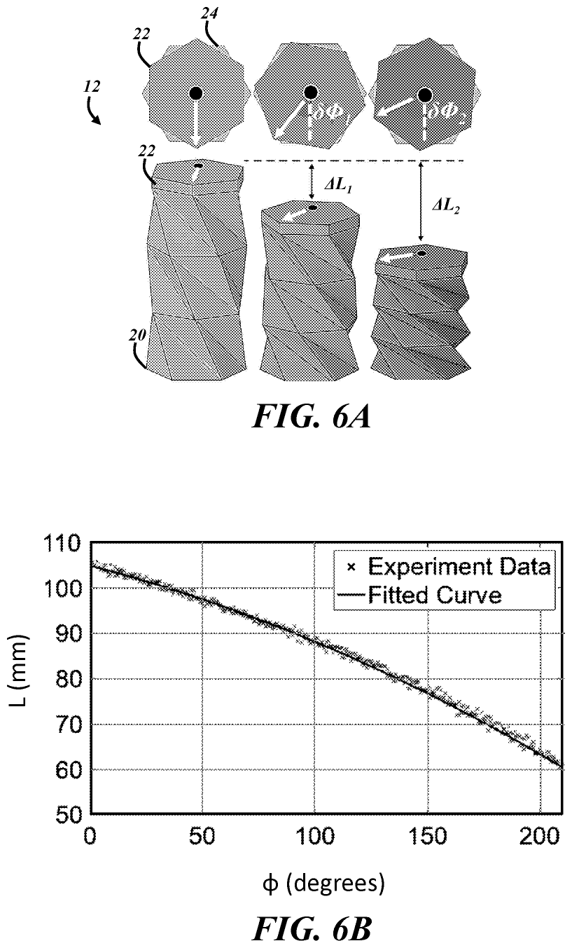

As illustrated in FIGS. 6A and 6B, there is a defined relationship between the amount of rotation of the second end 22 of each actuator 12 and its change in length ΔL. When the controller 38 operates to retract one of the actuators by a particular amount ΔL, the controller actuates the associated valve 36A and monitors the shaft angle Φ until it reaches a value correlated to the desired change in length ΔL. An illustrative relationship of actuator length L to angle of rotation Φ of an end of the actuator is given in FIG. 6B. The robot 10 can therefore be configured to self-sense changes in actuator length and monitor actuator length in real time via the shaft angle sensors 58.

The IMU 60 is configured to provide the controller 38 with information about the position and orientation, along with corresponding velocities and/or accelerations, of the rear end of the robot 10. In some embodiments, an IMU is additionally or alternatively provided at the first end portion 16 of the robot. The angle sensors 58 and IMU 60 may be considered as part of the sensor system 44 that provides information to the controller 38 about the robot itself—i.e., the object sensors 48, 50 may be considered external sensors, while the sensors 58, 60 may be considered internal sensors of the sensor system 44. The multiplexer 62 is configured as an intermediate switch between the multiple sensors of the sensor system 44 and the controller 38 such that the controller requires only one connection to the sensor system rather than having dedicated inputs for all of the sensors. The motor driver 64 drives the pump 32, taking the power from power source plugs 56 and providing a driving voltage to the pump power plug 54. In FIG. 5, the back side of the controller 38 is visible through an opening 66 in the control board 30. The opening 66 may accommodate communication and/or pressure lines extending from the valves 36 and/or controller 38 to the opposite side of the control board.

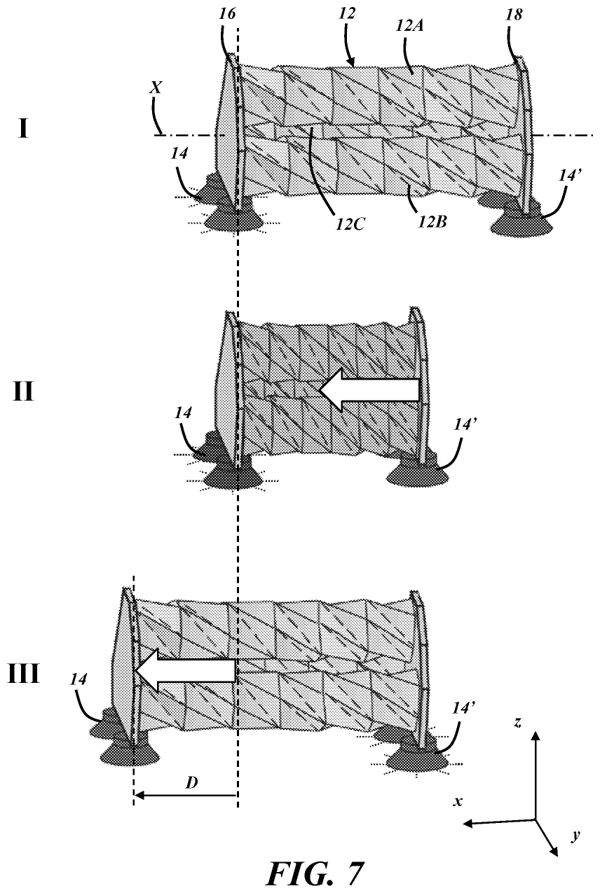

FIG. 7 schematically illustrates simple linear movement of the robot 10 along an upwardly facing horizontal surface. From the fully extended condition I, the suction cups 14 at the first end portion 16 are activated (indicated by dotted lines) and the suction cups 14′ at the second end portion 18 are deactivated, thereby attaching the front end of the robot 10 to the underlying surface while leaving the rear end free to move. Then, a vacuum is applied to the internal volume of all of the flexible tube actuators 12, causing all of the actuators to retract (shorten) as shown in condition II such that the second end portion 18 is moved toward the first end portion 16 in the longitudinal (x) direction. While the actuators 12 are retracted, the suction cups 14′ at the second end portion 18 are activated to attach the rear end of the robot to the underlying surface. Then, the suction cups 14 at the first end portion 16 are deactivated and the internal volumes of the actuators 12 are repressurized (i.e., the vacuum is removed). In response, the actuators 12 extend (lengthen) as shown in condition III such that the first end portion 16 is moved away from the second end portion 18 in the same longitudinal (x) direction such that the entire robot 10 has moved a distance D in translation.

In actual operation, the rear end of the robot 10 may be raised away from the underlying surface during the transition from condition I to condition II. This can be effected by a small retraction of the top actuator 12A before full retraction of all of the actuators, such as by initiating the retraction of the top actuator prior to initiating the retraction of the other two actuators. Similarly, the front end of the robot 10 may be raised away from the underlying surface during the transition from condition II to condition III. This can be effected by a small extension of the lower actuators 12B-C before full extension of all of the actuators, such as by initiating the extension of the lower actuators prior to initiating the extension of the top actuator. These movements are examples of bending movements of the robot 10 effected in the x-z plane. 3D bending is also possible. For example, with the front suction cups 14 deactivated and the rear suction cups activated and the actuators 12 retracted as in condition II, upward and sideward bending of the robot 10 can be effected by delayed extension of the top actuator 12A and one of the lower actuators 12B, 12C relative to the other lower actuator. Under these conditions, a central axis X of the robot 10 (in this case at the center of the triangular pattern of the central axes of the individual actuators 12) will generally exhibit bending toward the two actuators with delayed extension. If, from the retracted condition II of FIG. 7, actuator 12C is extended while extension of actuators 12A and 12B is delayed or performed at a slower rate, the robot 10 will exhibit bending that is both upward (z) and in a direction (y) out of the page.

The linear and bending motion is enabled in part by the flexibility of the material from which the actuators 12 are made. While rigid materials such as sufficiently thin metal may be able to fold and unfold in the manner of hinge-type springs, the Kresling-like fold line pattern shown here results in deformation of the fold lines—specifically the diagonal fold lines—during retraction from the free state. A rigid material would either not permit such deformation or would permanently deform as a result. The flexibility of the actuator material also permits the more fully extended actuator(s) to bend away from their straight free-state when the other actuator(s) are more retracted. Design parameters of the actuators 12 involve certain trade-offs. For example, the retraction ratio—i.e., the distance D in length L between the fully retracted and extended conditions as a percentage of the fully extended length—is higher with a lower actuator wall thickness. However, a wall thickness that is too low can lead to cracks in the actuator wall on repeated cycles. Using a TPE material, the wall thickness may be in a range between 0.5 mm and 1.0 mm while achieving a retraction ratio of about 50% to 70% under a 60 kPA vacuum.

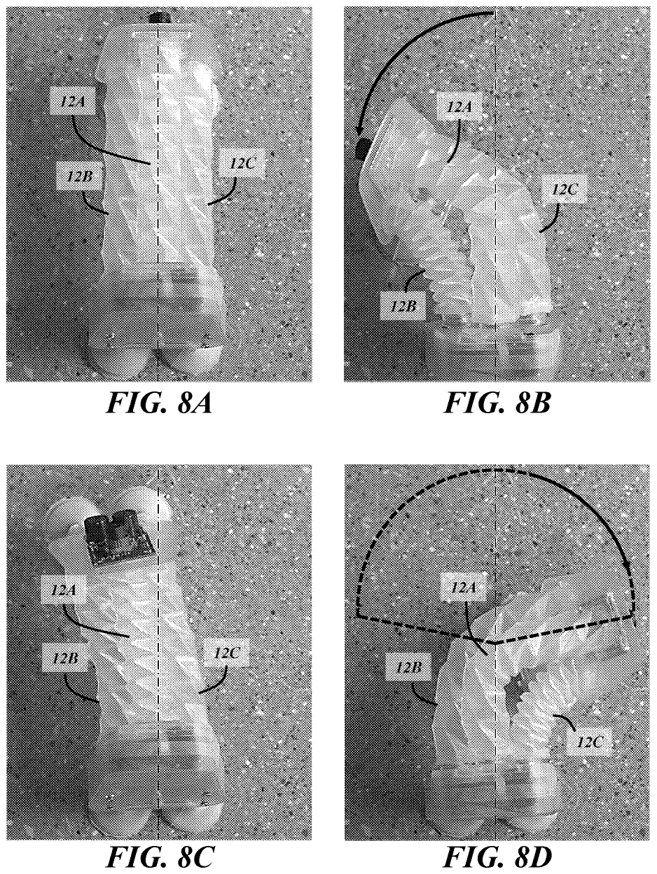

FIGS. 8A-8D are overhead photographic images illustrating multiple bending movements of a prototype soft robot according to the above description. FIG. 8A shows the robot resting on the ground with all actuators 12A-12C in the fully extended condition. With the rear feet 14′ activated and attached to the ground as in FIG. 7A, the lower-right actuator 12B was retracted while the top and lower-left actuator 12A, 12C remained extended, resulting in the leftward bending movement of FIG. 8B. From the leftward bending movement of FIG. 8B, actuator 12B was extended, and then, just before full extension, the top actuator 12A was retracted, resulting in the upward bending movement of FIG. 8C. From the upward bending movement of FIG. 8C, actuator 12A was extended, and then the lower-right actuator 12C was retracted, resulting in the rightward bending movement of FIG. 8D.

As shown in FIG. 8D, these movements define an approximately conical range of movement of the front end of the robot relative to the rear end. The controller 38 is configured to selectively extend and retract the actuators 12 via valve actuation to cause the front of the robot 10 to move with respect to the rear of the robot (or vice versa) in the desired direction. In one example, the robot 10 uses the optical sensor 50 and the controller 38 is configured to recognize objects via shapes, colors, contrast, etc., and to navigate the robot 10 with respect to the recognized objects.

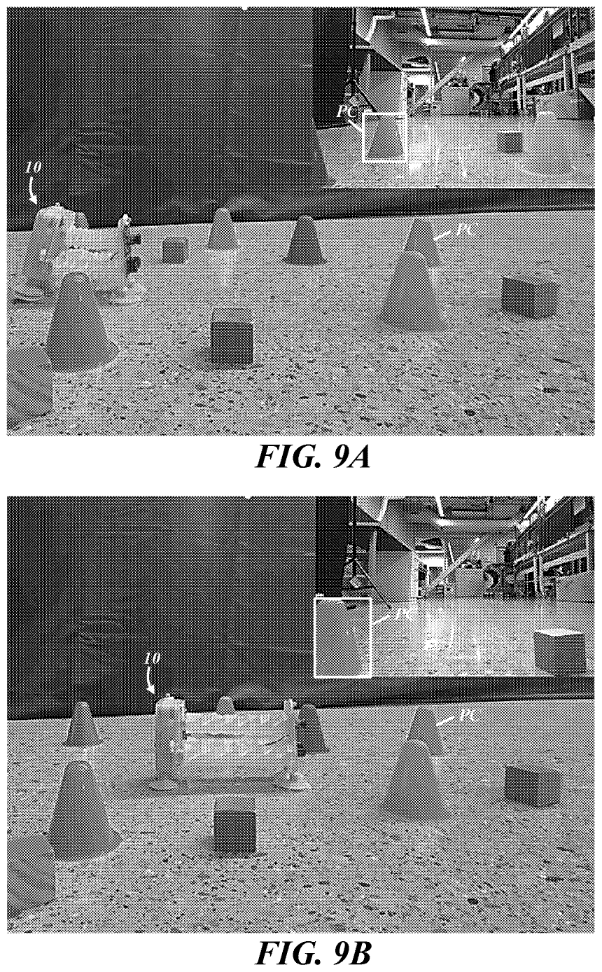

FIGS. 9A and 9B are photographic images of the prototype robot 10 of FIGS. 8A-8D ambulating along a path through several differently shaped and differently colored objects along the ground. The upper-right inset image of each of FIGS. 9A and 9B shows the real-time imagery being captured by the robot's 10 vision system. Here, the controller 38 was configured to recognize a particularly shaped (conical) and colored (pink) object PC from the field of objects. From there, the controller 38 can either navigate the robot 10 toward the detected object or navigate the robot so that its path avoids the object, as in FIG. 9B. The distance sensors 48 can help the controller determine how drastic the robot's bending motions must be to reach or avoid the object by the time its distance closes.

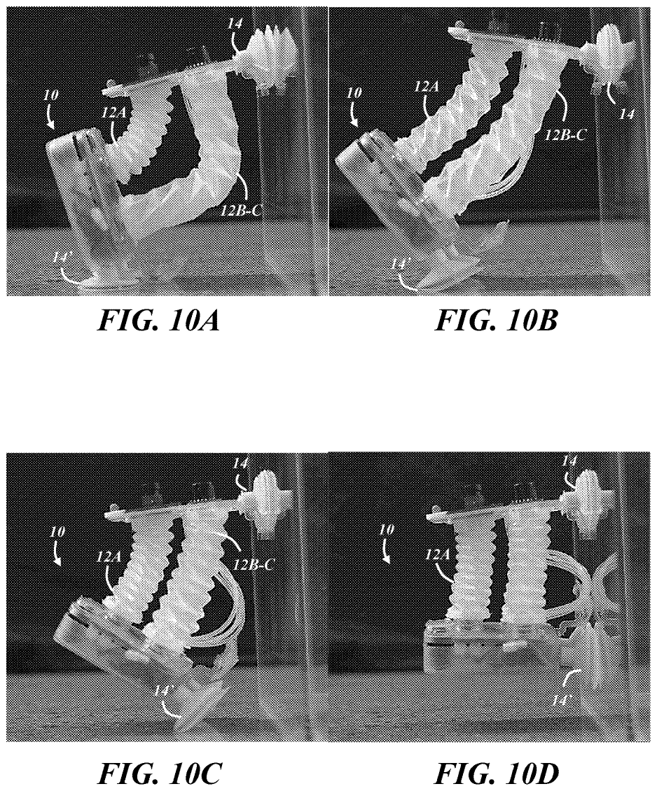

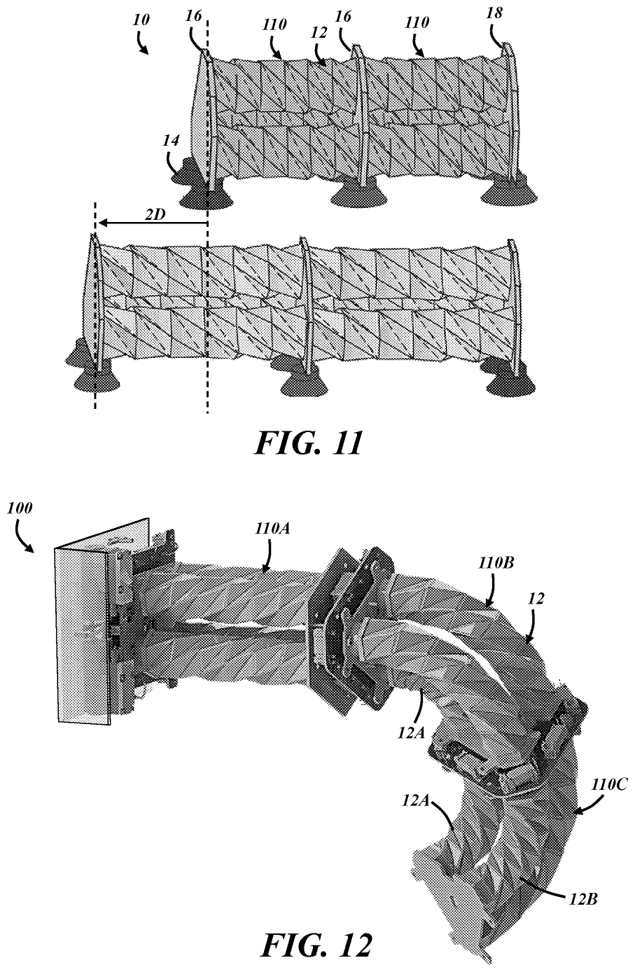

FIGS. 10A-10D are photographic images of a floor-to-wall transition being performed by the prototype robot of the previous figures. FIG. 10A illustrated the robot 10 with its rear feet 14′ activated on the floor, the top actuator 12A retracted, and the lower actuators 12B-12C extended. The front feet 14 are deactivated and resting on a vertical glass surface. From this position, the robot 10 first activates the front feet 14 to attach them to the vertical surface, then deactivates the rear feet 14′, and then extends the top actuator 12A as in FIG. 10B to tilt the rear of the robot backward toward the floor. From this position, all of the actuators 12 are retracted to begin to lift the rear end of the robot as in FIG. 10C. The actuators 12 are all retracted in FIG. 10D, after which the rear feet can be activated so that the robot 10 can navigate along the vertical surface.

FIG. 11 illustrates another embodiment of the soft robot 10 that includes two actuator modules 110 in accordance with the subsequent description of embodiments of a robotic assembly 100 that employs such modules. The tandem arrangement of modules 110 in FIG. 11 results in a greater range of movement (2D) per ambulation cycle and a greater bending range of the robot such that the robot can navigate 90-degree turns, for example. The bending movements of the robot can also be more complex than with the single module of the previous example. The larger range of bending movement facilitates an easier transition between horizontal and vertical surfaces. In summary, each module 110 has identical individual actuators 12 extending between rigid portions 16, 18 equipped with feet 14. Each module 110 includes an identical front or first rigid portion 16, and only the rearmost module has a second or rear rigid portion 18 that mates with the housing that contains the robot control system. The internal pressure of each actuator 12 is individually controlled via valve actuation to extend or retract each individual actuator. Each pair of feet 14 is also individually controlled. As discussed further below, each actuator module 110 may include its own control board carrying the valves controlling the extension and retraction of the actuators of that module.

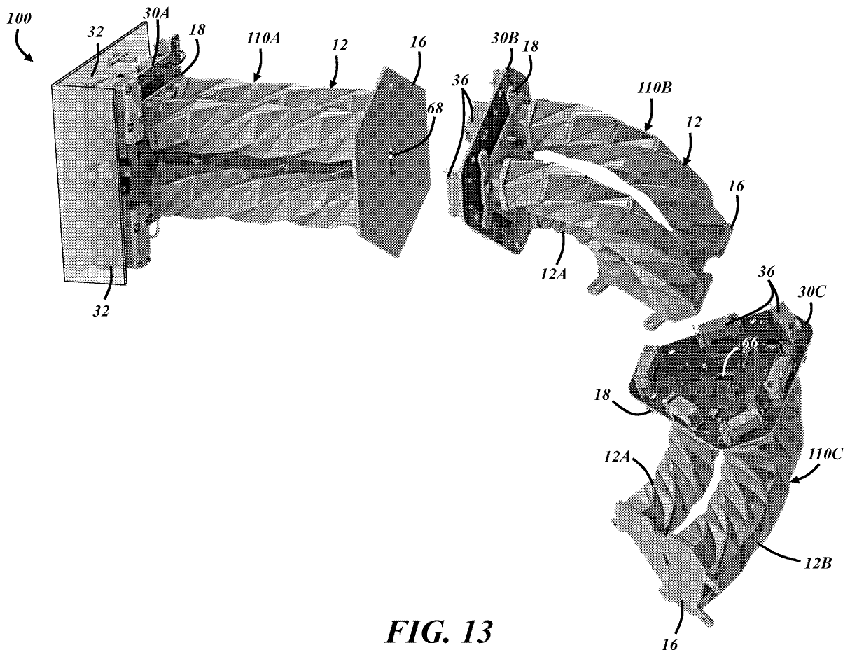

FIG. 12 is a perspective view of a modular soft robotic assembly 100 constructed from a modular soft robotic system including a plurality of multi-tube actuator modules 110 employing the above-described flexible tube actuators 12. The illustrated assembly 100 is a robotic arm. The actuator modules 110 include a base module 110A and at least one extension module arranged end-to-end. The illustrated robotic arm 100 includes two extension modules 110B, 110C. The actuators 12 are constructed in accordance with the above description and extend and retract based on internal fluid pressure—i.e., applied a vacuum to the internal volume of each actuator 12 causes it to retract from its extended free state. The actuators 12 of the base module 110A are illustrated in the extended condition. One actuator 12A of the first extension module 110B is retracted, and two actuators 12A, 12B of the second extension module are retracted, resulting in a downward bend in the first extension module 110B and a sideward bend in the second extension module 110C. Further description of the robotic arm 100 is made with reference to the partially exploded view of FIG. 13.

Each multi-tube actuator module 110 includes a plurality of flexible tube actuators 12 attached to and extending between first and second rigid end portions 16, 18. Each module 110 also includes a control board 30 configured to independently control the internal fluid pressure of each of the flexible tube actuators 12 to extend and retract each of the actuators. Each of the control boards 30 includes at least one valve 36 regulating the internal pressure of each of the actuators 12 of each module 110, and the robotic arm 100 includes at least one pump 32 in fluidic communication with the valves 36 of each control board 30. In this example, the assembly 100 includes two air pumps 32 mounted along the control board 30A of the base module 110A, and each control board 30 includes two valves 36 for each actuator 12 of the respective module 110. For example, a pressure line (not shown) may extend from each pump 32 to the valves 36 of the control boards 30 of the extension modules 110B-C through openings in the control boards 30 and/or openings 68 in the end portions 16, 18. As with the above-described soft robot 10, each control board 30 may include a manifold 40 connecting each valve 36 of one of the control boards 30 to the common pressure line.

The base module 110A may be configured to support a greater bending load than the extension modules. For example, the base module 110A may include a greater number of actuators 12 than the extension modules. In the illustrated example, the base module 110A includes four flexible tube actuators 12, while the extension modules 110B-C include three actuators each. Alternatively or additionally, the actuators 12 of the base module 110A may have a greater wall thickness and/or be constructed from a more rigid material than the actuators of the extension modules. The additional strength or rigidity of the base module 110A helps support the additional weight of the extension modules.

The control boards 30 of the various modules 110 may be arranged in a primary-secondary or leader-follower configuration in which the controller 38 of the base module 110A is the main controller 30 A sending commands to the control boards 30B, 30C of the extension modules. The base module controller may, for example, send commands to one or more of the control boards 30 of the extension modules to retract one of an extension module's actuators 12. The control board 30B, 30C of the specific extension module 110B, 110C that includes the actuator 12 being commanded to retract will actuate the associated valve(s) 36 and monitor the rotation of the associated shaft to achieve the result required by the main controller 30A. As discussed further below, the pump(s) may be in fluidic communication with each actuator via two valves arranged in series to fix one actuator length at the desired condition while the other actuators continue to change length. The main control board 30A may be in communication with the secondary control boards 30B, 30C via a communication line extending along the length of the arm 100 (e.g., through openings 66, 68) or wirelessly. The communication line may include or run alongside an electrical line and/or a pressure line by which the control boards 30B, 30C, including their valves 36, are powered and operated.

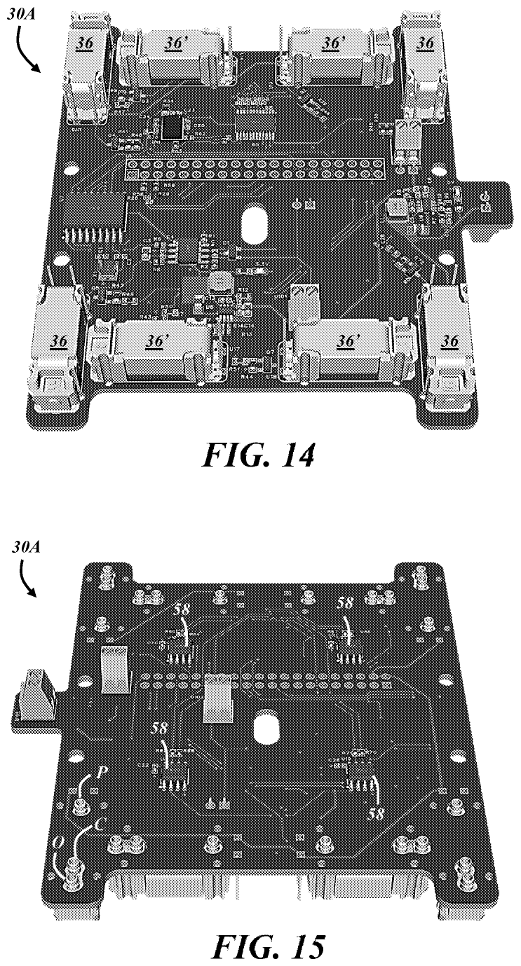

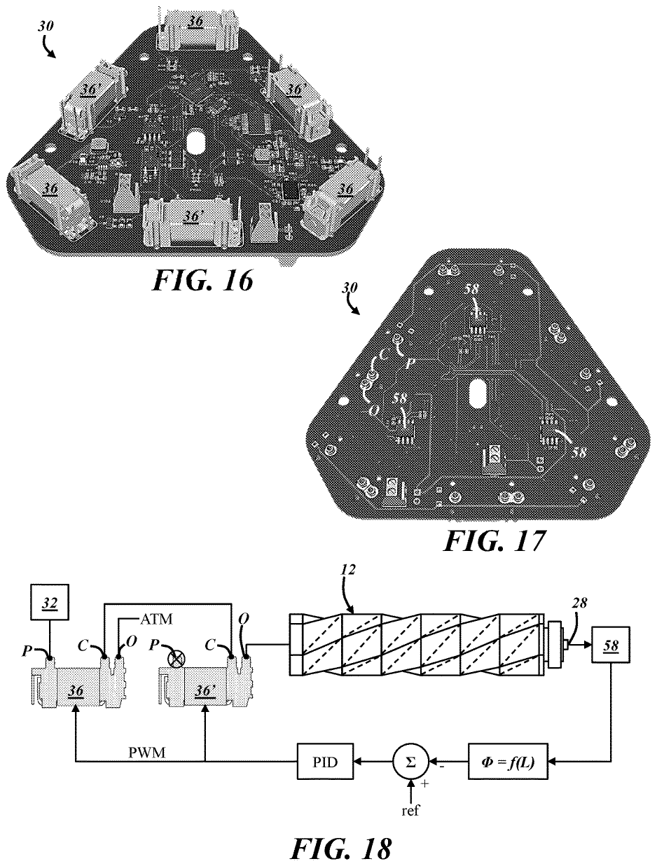

FIG. 14 is a perspective view of a first side of the control board 30A of the base actuator module 110A of FIGS. 12 and 13, which is the side facing away from the second rigid portion 18 of the base module. The controller 38 is omitted in FIG. 14 but may be the same or similar to the controller 38 of FIGS. 3-4. The control board 30A carries two valves 36, 36′ for each actuator 12 of the base module 110A, for a total of eight valves in this example. One valve 36 of each pair of valves 36, 36′ is configured as a 3-way valve, and the other valve 36′ of each pair is configured as a 2-way valve. In this embodiment, the valve ports P, C, O extend through openings to the opposite side of the control board 30 as shown in FIG. 15 (see lower-left corner of FIG. 15). With this configuration, the valves 36, 36 are more easily accessed on the side of the control board 30 facing the actuators. This is the same side of the control board 30A that includes the shaft angle sensors 58, positioned to face the ends of the shafts that provide the rotational coupling of each actuator 12 to the second rigid portion 18. Similarly, FIGS. 16 and 17 are respective perspective views of opposite first and second sides of the control boards 30 of the extension modules 110B-C of FIGS. 12 and 13. The control boards 30 each carry two valves 36, 36′ for each actuator 12 of the extension modules 110B-C, for a total of six valves in this example. As with control board 30A, the valve ports P, C, O extend through openings to the opposite side of the control board 30, which includes the shaft angle sensors 58, as shown in FIG. 17.

Returning to FIG. 12, the soft robotic assembly 100 may include a housing 26 containing the main control board 30A, the pump(s) 32, and, if the assembly 100 is untethered, a power source such as a battery. As a robotic arm, the assembly 100 may be configured such that the housing 26 is mounted to a wall or other stationary fixture and may include a manipulator or other accessory at the first end 16 of the extension module furthest away from the base module 110A. While not shown explicitly in this example, a sensor system of the robotic arm 100 may include optical sensors, distance sensors, or other sensors at its distal end or elsewhere along its length. A camera mounted at the end of the second extension module, for example, can provide the robotic arm with remote vision capability to provide visual information to a human user or to use for its own navigation around obstacles. Embodiments of the soft robotic assembly 100 include an untethered power source, as in FIG. 3, powering the pump(s) 32 and control boards 30 along with feet 14 like those described in conjunction with the soft robot 10 of FIGS. 1-10D mounted along each of the rigid end portions 16, 18 of the assembly and in fluidic communication with the pump(s). The assembly 100 may additionally include one or more sensors configured to detect objects and a controller at one of the control boards 30 configured to receive information about detected objects and control extension and retraction of each actuator of the assembly based on the received information. The result is a modular soft robot 10 as in FIG. 11 having all of the features of the soft robot 10 of FIGS. 1-10D and of the soft robotic arm 100 of FIGS. 11-14.

FIG. 18 schematically illustrates closed-loop control of actuator length using multi-valve control of each actuator 12. The low pressure side of the pump 32 is in fluidic communication with the internal volume of each actuator 12 via a pair of dedicated valves, one of which operates as a 3-way valve 36 and the other of which operates as a normally closed (NC) 2-way valve 36′. The valves 36, 36′ are in a series arrangement in which the pump 32 is in fluidic communication with port P of the first valve 36, port C of the first valve 36 is in fluidic communication with port C of the second valve 36′, and port O of the second valve 36′ is in fluidic communication with the internal volume of the respective actuator 12. Port O of the first valve 36 is connected to atmosphere. Each valve 36, 36′ is controllable to selectively connect port C to either port P (default position) or port O (actuated position). Port P of the first valve 36 is always open to the pump 32, and Port P of the second valve is always closed so that the second valve 36′ is effectively a 2-way valve that is normally closed and opens to connect the first valve 36 to the actuator 12.

When a change in length of one or more of the actuators 12 is required to bring the robotic arm into a particular shape and orientation, a controller modulates the valves 36, 36′ and monitors the angle Φ of the shaft 28, which is a function of actuator length L, until the desired length is achieved. For example, to retract (shorten) the illustrated actuator 12 from a particular length, both valves 36, 36′ are actuated such that the pump 32 is connected with port C of the first valve 36 (rather than atmosphere) and the second valve is in the open condition, effectively connecting the pump 32 with the actuator 12. As the actuator 12 retracts, a controller (a PID controller in FIG. 18) monitors shaft angle Φ via the shaft angle sensor 58 and closes the second valve 36′ when the respective actuator reaches the desired length. Inclusion of the second valve 36′ permits one of the actuators 12 to stop retracting or extending while other actuators of the module 110 can continue to change in length—which is required for bending movement of the respective module. The valves 36, 36′ may be controlled via pulse width modulation (PWM) to control the relative rates of actuator length changes. In the case of the base module 110A, the controller may be the controller 38 of the primary control board 30A, while the valves of the extension modules 110B-110C may be controlled by a dedicated controller 38 on the respective control board 30B-30C based on instructions from the primary controller. For actuator extension (lengthening), the respective second valve 36′ is opened and the first valve 36 connects the pump 32 to atmosphere. The first valve 36 thus acts to control the direction of length change (extension or retraction), while the second valve 36′ acts to stop or start the length changes. It should be understood that the same or similar valve control scheme can be implemented on the above-described soft robot 10.

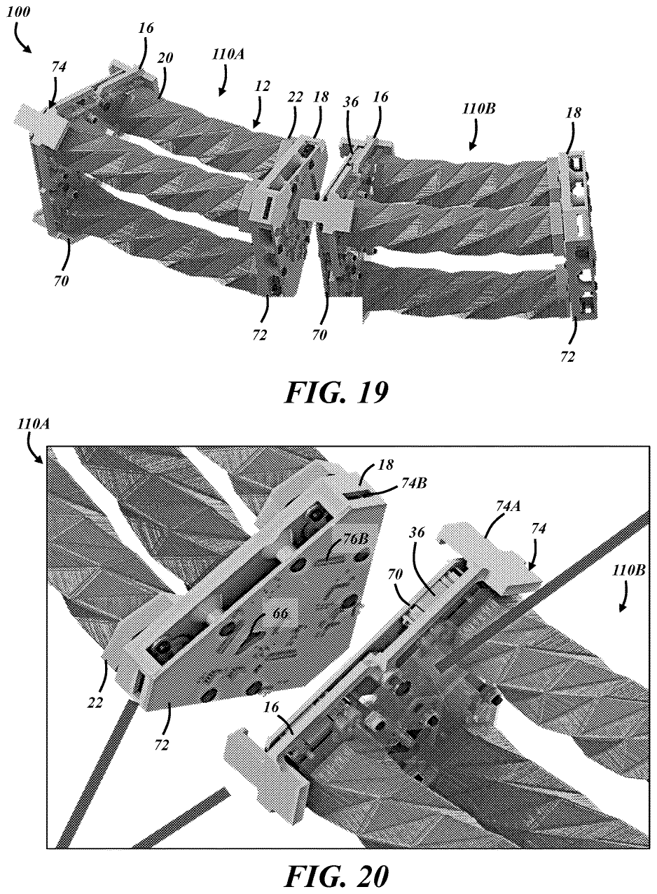

FIGS. 19 and 20 illustrate another example of actuator modules 110A, 110B of a modular soft robotic system configured to form a soft robotic assembly 100 with improved modularity. Each of the illustrated modules 110A, 110B can be an extension module, or, with certain modifications discussed below, the first module 110A can be converted to a base module (as module 110A in FIGS. 12 and 13). Here, the functions of the control boards 30 of the previous example are divided into two boards at opposite ends of each module, including an actuation board 70 at the first or proximal end portion 16 and a sensing board 72 at the second or distal end portion 18. Stated differently, each of the above-described control boards 30A-30C is both an actuation board 70 and a sensing board 72. Dividing the actuation and sensing function and locating them at opposite ends of the respective module can provide for better modularity and permit additional sensing capabilities to be added to the extension module furthest from the base module. As with the previous examples, the first end portion 16 is where the static end 20 of each actuator 12 is attached and the second end portion 18 is where the rotatable end 22 of each actuator is attached. However, in this example, the first and second end portions 16, 18 are reversed from the previous examples such that the static ends 20 of the actuators are at the proximal end (nearest the base) of each module. Each module 110A-B is also equipped with a modular fastening system 74 to enable easy attachment and detachment of modules from each other in a manner that provides all of the required electrical connections between modules.

In this example, the actuation board 70 includes the above-described valves 36, 36′ on the side of the board facing the actuators 12 of the respective module 110, and the sensing board 72 includes the above-described shaft angle sensors 58 on the side of the board facing the actuators of the respective module. Each actuation board 70 is like the control boards 30 of the previous example except without the shaft angle sensors 58—i.e., configured to actuate the valves based commands from the main controller and/or a microcontroller of the module and on real-time feedback from the shaft angle sensors of the sensing board 72 at the opposite end of the respective module.

FIG. 20 is an enlarged view of the interface between two modules 110A and 100B. FIG. 20 illustrates the second rigid end portion 18 of the first module 110A and the first rigid end portion 16 of the second module 110B. Each board 70, 72 is rigidly attached to the respective end portion 16, 18 and may add rigidity thereto. The end portions 70, 72 of the modules are removably coupled with each other via the fastening system 74, which includes a first fastening portion 74A as part of the first end portion 16 of the second module 110B and a complimentary second fastening portion 74B as part of the second end portion 18 of the first module 110A. In this example, the fastening system 74 is of the snap-fit variety with cantilevered arms 74A as the first fastening portion and openings 74B in the second end portion 18 as the second fastening portion. A radially inward protrusion of each arm 74A snaps into the respective opening 74B to couple the respective end portions 16, 18 and can be flexed radially outward to release the end portions from each other. This is only one example of a suitable fastening system. The arms and openings 74A, 74B may be reversed or on both end portions, for example. In one embodiment, the fastening system 74 is magnetic, with one end portion 16, 18 or board 70, 72 having magnets and the other end portion or board having a complimentary magnet or ferromagnetic material.

The back sides of the respective boards 70, 72 are configured to form electrical connections between adjacent modules 110A, 110B. In this case, the actuation board 70 and the sensing board 72 have first connector portions 76A (not visible in FIG. 20) and second connector portions 76B that form assembled connectors when the actuator modules 110A, 110B are coupled by the fastening system 74. The assembled connectors provide electrical power from the first module 110A to the second module(s) and provide for electrical communication of control signals and/or sensor signals between interconnected modules. The second module 110A can be in fluidic communication with the pump(s) of a base module and/or another extension module via a pressure line 42 (not shown) extending through openings 66 or fluid line connectors of the respective boards, and the boards at the opposite ends 16, 18 of each module may be electrically connected via electrical lines 46 extending therebetween (see for example the communication and pressure lines 42, 46 of FIG. 1).

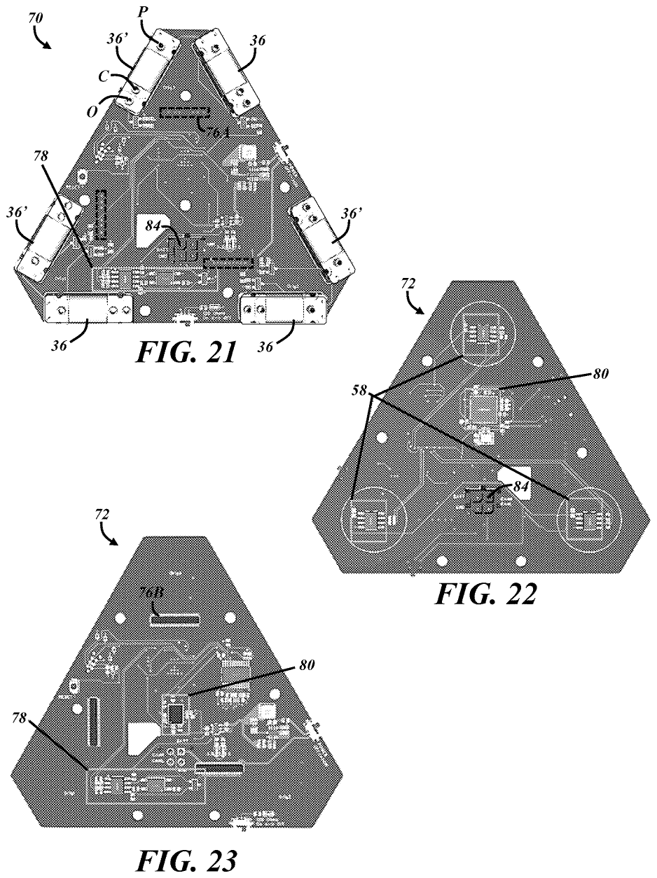

FIG. 21 is a plan view of a valve side of the actuation board 70 at the first end portion 16 of each module 110A, 110B of FIGS. 19 and 20, where each module 110A is an identical extension module. The control board 70 has pairs of valves 36, 36′ associated with each actuator of the respective module. This is the side of the actuation board 70 facing toward the fixed end 20 of the actuators of the respective actuator module. The actuation board 70 includes a controller area network (CAN) bus 78 by which the actuation board 70 is in communication with the sensing board 72 of the same module and/or the main controller of a base module. The opposite connector side of the actuation control board 70 includes first connector portions 76A that are arranged and configured to mate with and form a connector with each of the second connector portions 76B of the sensing board 72 of an adjacent actuator module.

FIG. 22 is a plan view of a sensor side of the sensing board 72 at the second end portion 18 of each module 110A, 110B of FIGS. 19 and 20, where each module is an extension module. FIG. 22 illustrates the shaft angle sensors 58 associated with each actuator of the respective module, as well as a microcontroller 80 for modulating the valves 36, 36′ of the actuation board based on commands from the main controller of a base module and on real-time feedback from the shaft angle sensors 58. This is the side of the sensing board 72 facing toward the rotating end 22 of the actuators of the respective actuator module. The microcontroller could alternatively be part of the actuation board 70.

The opposite connector side of the sensing board 72 is shown in FIG. 23 and includes a controller area network (CAN) bus 78 by which the sensing board 72 is in communication with the actuation board 70 of the same module and/or the main controller of a base module. This side of the sensing board 72 also includes an IMU 60 for detecting the relative position, orientation, and movement speed of the second end portion 18 of the module. The connector side of the sensing board 72 includes second connector portions 76B that are arranged and configured to mate with and form a connector with each of the first connector portions 76A of the actuation board 70 of an adjacent actuator module.

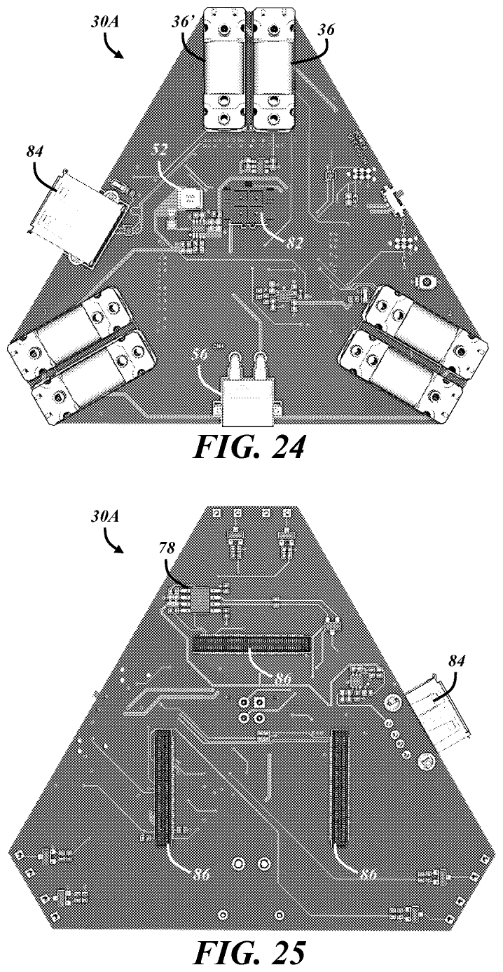

FIGS. 24 and 25 are plan views of respective valve and connector sides of a main control board 30A of a base actuator module such as module 110A of FIGS. 12 and 13. The illustrated control board has all of the functionality of the actuation board 70 discussed in conjunction with FIG. 19-21 and can be used in place of the actuation board 70 of one of the modules 110A, 110B of FIG. 19 to convert that module into a base module.

FIG. 24 shows the valve side of the control board 30A which would be at the first end portion 16 of the base module. This is the side of the control board 30A facing toward the fixed end 20 of the actuators of the base module. As with the actuation board 70 described above, the control board 30A has pairs of valves 36, 36′ associated with each actuator of the base module. The illustrated control board 30A also includes a voltage regulator 52, a power source connector 56, an intramodule connector 82, and a WiFi adapter connector 84. The voltage regulator 52 controls the voltage being supplied to all of the boards 30A, 70, 72. The intramodule connector 82 is configured to receive multiple electrical lines (e.g., a harness) carrying power and communications from one end of the base module to the other. The previously described actuation and sensing boards 70, 72 include such a connecter as well.

FIG. 25 illustrates the opposite side of the main control board 30A, which faces away from the actuators 12 of the base module and includes a CAN bus 78 by which the main control board 30A is in communication with the sensing board 72 of the same module and the microcontrollers 80 of the extension modules. This side of the main control board 30A also includes connectors 86 configured to receive the main controller 38 (e.g., as in FIG. 4). In some embodiments, the control board 30A also includes one or more pump in fluidic communication with the actuators of the base module and with the actuator board 70 of each extension module.

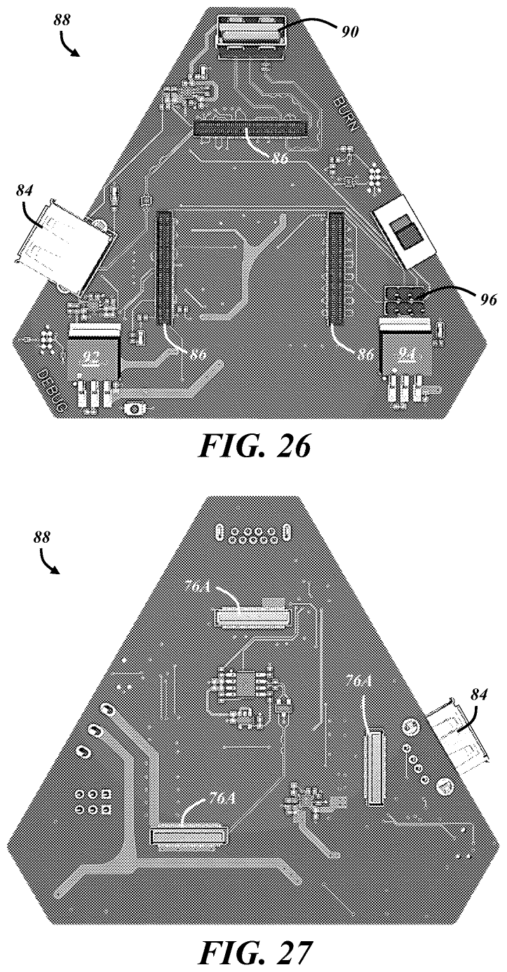

FIGS. 26 and 27 are plan views of respective camera and connector sides of a sensor system board 88 configured to carry a camera or other optical or distance sensors at the distal end of the robotic arm—i.e., at the second end portion 18 of the extension module furthest from the base module. This module 88 is optional and is configured for attachment to the side of the sensing board 72 facing away from the actuators of the respective actuator module—i.e., on the opposite side of the sensing board from the shaft angle sensors.

The camera side of the board 88 shown in FIG. 26 is the side of the board facing away from the actuators of the module to which the board 88 is attached and includes a WiFi adapter (e.g., USB 2.0) connector 84, connectors 86 for a dedicated controller (e.g., OrangePi compute module 5) of the sensor system board 88, a sensor connector 90 (e.g., USB 3.0), voltage regulators 92, 94 for the USB connectors 84, 90 and the controller connectors 86, and output pins 96 for connection to and control of an end effector for the robotic arm. The sensor connector 90 is configured for connection of a camera or other sensor able to provide real-time images or information about the environment at the distal end of the robotic arm. The controller connectors 86 permit the board 88 to provide its own computing power separate from that of the base module and main controller 30A. This board 88 may also include a dedicated power source or may be powered by the power source of an attached camera, with the voltage regulators converting the power source voltage to voltages used by the board 88. The controller may be configured to provide output voltages or signals at the output pins to control an end effector, such as a gripper or other tool based on imagery from the camera and/or inputs from a user viewing the imagery. In some cases, the controller attached to the sensor system board 88 may be configured to be the main controller of the robotic arm and in communication with the microcontrollers of the individual modules.

FIG. 27 illustrates the opposite side of the sensor system board 88, which faces toward the actuators 12 of the final extension module. This side of the board 88 includes a CAN bus 78 by which the board 88 and its controller are in communication with the other modules, as well as connector portions 76A arranged and configured to form connectors with the connector portions 76B of the sensing board 72 to which it is attached.

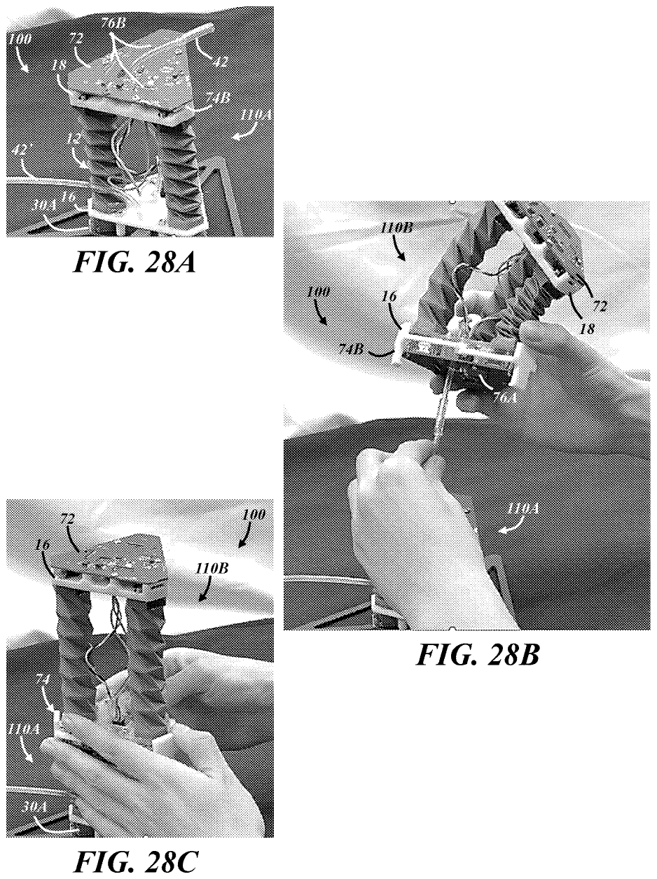

FIGS. 28A-C are photographic images of a working prototype of the above-described robotic arm 100 sequentially showing attachment of an extension module 110B to a base module 110A. Reference numerals are added to corresponding features of the above description. With reference to FIG. 28A, the base module 110A includes first and second rigid end portions 16, 18 with flexible tube actuators 12 extending therebetween and with their rotating ends at the second end portion 18. The main control board 30A is at the first end portion 16, and a sensing board 72 is at the second end portion 18. Connector portions 76B of the sensing board 72 are visible in FIG. 28A. An external vacuum source 42′ is provided at the first end portion 16 and the valves on the main control board 30A. A pressure line 42 extends from a connector on the first end portion 16 and through an opening in the sensing board 72 to a free end.

In FIG. 28B, the free end of the pressure line 42 of the base module 110A is being connected to a pressure line 42″ extending through the actuation board 70 of an extension module 110B, effectively placing the external vacuum source 42′ in fluidic communication with the actuators of the extension module 110B via the valves carried by the actuation board 70. The extension module 110B is the same as the base module, except for the first end portion 16 and control board 30A. The first end portion 16 of the extension module 110B includes fastener portions 74A configured to engage with the fastener portions 74B of the second end portion of the base module 110A, as well as connector portions 76A configured to form connectors with the connector portions 74B of the second end portion of the base module.

In FIG. 28C, the first end portion 16 of the extension module 110B is attached to the second end portion 18 of the base module 110A via the fastening system 74, which forms electrical connections between the two modules via the first and second connector portions 76A, 76B. The added module 110B already includes electrical power and communication lines extending between the boards 70, 72 at its opposite ends. The extension module 110B is plug-and-play in that the main control board 30A detects the addition of extension modules and modifies its controlled movement of each actuator module according to the new geometry of the multi-module robotic assembly 100.

As with the robotic assembly of FIGS. 12 and 13, the modules of FIGS. 19 and 20 can be used as the basis for a soft robot 10 by adding foot assemblies 14 to the end portion 16, 18 and alternating extension and retraction of the actuators of one or more modules with attachment and detachment of the feet 14 to the underlying surface timed such that a front end portion is detached and permitted to move over the surface and a rear end portion is attached to the surface during actuator extension, and such that the rear end portion is detached and permitted to move over the surface and the front end portion is attached to the surface during actuator retraction.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A modular soft robotic system comprising a plurality of multi-tube actuator modules configured to be operably connected end-to-end, each actuator module having a plurality of flexible tube actuators extending between first and second rigid end portions,
wherein each actuator of each module has a length that is individually controllable by modulating an internal fluid pressure of the respective actuator, and
wherein the first end portion of each module is configured for removable attachment to the second end portion of another of the modules to form a modular soft robotic assembly in which each module is in electrical communication with a controller and in fluidic communication with a fluid pump.

2. The system of claim 1, each actuator module further comprising an actuation board at one of the end portions and a sensing board at one of the end portions, the actuation board comprising a plurality of valves and the sensing board comprising a plurality of angle sensors, wherein the internal pressure of each actuator is modulated by controlling a corresponding one of the plurality of valves and a change in the length of each actuator is monitored via a corresponding one of the plurality of angle sensors.

3. The system of claim 2, each actuator module further comprising a control board that includes the actuation board and the sensing board at the same end portion of the module, the control board comprising a controller configured to change the length of each actuator by modulating the internal fluid pressure of the respective actuator using the valves and monitoring the change in the length of each actuator using the angle sensors.

4. The system of claim 2, wherein the actuation board is at one of the end portions and the sensing board is at the other of the end portions, one of the actuation or sensing boards comprising a controller configured to change the length of each actuator by modulating the internal fluid pressure of the respective actuator using the valves and monitoring the change in the length of each actuator using the angle sensors.

5. The system of claim 4, wherein the actuation board of one module is operably connected with the sensing board of another module when two of the modules are removably attached to each other.

6. A modular soft robotic assembly formed from the system of claim 1, the assembly comprising at least two of the multi-tube actuator modules operably connected end-to-end, wherein one of the at least two actuator modules is a base module and each of the other of the at least two actuator modules is an extension module,
wherein the base module includes a main control board and each extension module includes a microcontroller, each microcontroller controlling the length of each of the respective actuators by modulating the internal fluid pressure of each actuator based on commands from the main control board.

7. The assembly of claim 6, further comprising a sensing system board removably attached to one of the extension modules, the sensing system board being configured for operable connection with a camera at a distal end of the assembly.

8. The assembly of claim 6, wherein the base module has a greater number of actuators than each extension module.

9. The assembly of claim 6, wherein the actuators of the base module have a greater wall thickness than the actuators of each extension module.

10. The assembly of claim 6, wherein the fluid pump is in fluidic communication with valves of each actuator module, the assembly further comprising:
an untethered power source powering the fluid pump and actuator module; and
feet at each end portion configured to controllably attach and detach the respective end portion to a surface supporting the robotic assembly, whereby the robotic assembly is an untethered soft robot.

11. The assembly of claim 10, further comprising a sensor configured to detect objects, wherein the main control board is configured to receive information about detected objects and control extension and retraction of each actuator of each actuator module based on the received information.

12. An untethered soft robot, comprising:
a plurality of flexible tube actuators configured to extend and retract via changes in internal fluid pressure; and
feet at opposite ends of the actuators, each foot being configured to temporarily and controllably fix the position of a respective portion of the robot with respect to a surface supporting the robot.

13. The robot of claim 12, wherein each actuator retracts by folding along fold lines defined along a wall of the actuator and extends by unfolding along the fold lines.

14. The robot of claim 12, further comprising first and second rigid end portions at opposite ends of the actuators, one end of each actuator being rigidly attached to one of the rigid end portions and the other end of each actuator being attached to the other of the rigid end portions with a rotational degree of freedom.

15. The robot of claim 14, wherein the plurality of actuators includes three actuators with central axes of the actuators arranged in a triangular pattern at each of the first and second rigid end portions.

16. The robot of claim 12, further comprising a sensor configured to detect objects and a controller configured to receive information about detected objects and control extension and retraction of each actuator based on the received information.

17. The robot of claim 12, further comprising:
an untethered power source;
a pump powered by the power source;
a plurality of separately controllable valves, each valve selectively interconnecting the pump with an internal volume of one of the actuators or with one of the feet; and
a controller configured to open and close each valve to independently control extension and retraction of each actuator and attachment and detachment of each of the feet from the surface supporting the robot.

18. The robot of claim 12, further comprising a first module that includes the plurality of actuators and the feet, wherein the actuators extend between first and second rigid end portions and the feet are attached to each end portion, the robot further comprising a second module comprising:
a plurality of additional and identical actuators extending between one of the rigid end portions and an additional rigid end portion;
additional and identical feet attached to the additional end portion; and
a controller mounted to one of the end portions and configured to extend and retract each actuator of each module and activate and deactivate each foot of each module.
